(19) United States
(12) Patent Application Publication
(10) Pub. No.: US 2025/0111063 A1
(43) Pub. Date: Apr. 3, 2025

(54) SYSTEMS AND METHODS FOR MANAGING COMPLIANCE WITH OBLIGATIONS

(71) Applicant: Radar, LLC, Portland, OR (US)

(72) Inventors: Nicholas J. CHURCH, Milwaukie, OR (US); Tate Jamison HENRY, De Soto, KS (US); Andrew Leigh BRASSAW, Portland, OR (US); Wendy L. DEMERS, Keizer, OR (US); Zelda Simone OLENTIA, Portland, OR (US); David VAN DER MERWE, Portland, OR (US)

(21) Appl. No.: 18/902,248

(22) Filed: Sep. 30, 2024

Related U.S. Application Data
(60) Provisional application No. 63/586,893, filed on Sep. 29, 2023.

(51) Int. Cl. G06F 21/60; G06F 3/0484

(52) U.S. Cl. CPC G06F 21/604; G06F 3/0484

(57) ABSTRACT

Methods and systems may include receiving and storing values for one or more configurable settings, wherein the configurable settings include first rules relating inputs to severity levels and second rules relating obligations to a respective threshold severity level. Inputs are received via a form displayed on the user interface, as one or more field values relating to an incident. An automated assessment is conducted to determine which obligations are triggered, by (a) determining an incident severity level based on the inputs and the first rules, and (b) determining which obligations are triggered based on whether the incident severity level meets the respective threshold for each obligation. Each triggered obligation and related information is displayed to the user for further input. Data from each incident may be archived for auditing purposes.

### CROSS-REFERENCES

The following applications and materials are incorporated herein, in their entireties, for all purposes: U.S. patent application Ser. No. 17/221,624, filed Apr. 2, 2021; U.S. Provisional Patent Application Ser. No. 63/586,893, filed Sep. 29, 2023.

### FIELD

This disclosure relates to systems and methods for managing compliance. More specifically, the disclosed embodiments relate to computer-implemented, user-configurable solutions for compliance management and documentation.

### INTRODUCTION

As cybersecurity (and other) event notification obligations become more strict, more punitive, and less well-defined, regulators often insist on clearly documented evidence that a risk assessment was performed as part of an organization's decision process regarding notification obligations. Organizations need a flexible, scalable, and configurable notification management solution to ensure compliance with obligations and mitigation of risks in today's complicated regulatory landscape.

### SUMMARY

The present disclosure describes a configurable compliance management system, as well as related methods. Configurable systems and methods may relate to an organization's assessment and response to incidents (e.g., cybersecurity incidents) that involve compliance with potential obligations, such as reporting requirements with respect to a particular jurisdiction. The configurable rules and assessment engine of the present disclosure is purpose-built for use by cybersecurity, information security (InfoSec), legal, and compliance teams. This solution offers organizations the ability to define their own compliance notification triggers and obligations with respect to internal and external stakeholders (e.g., boards of directors or federal regulators).

In some examples, a computer-implemented method includes: receiving, via a user interface, values for each of a plurality of configurable settings, wherein the configurable settings include first rules relating inputs to severity levels and second rules relating obligations to a respective threshold severity level; storing the one or more configurable settings in a memory; receiving as inputs, via a form displayed on the user interface, one or more field values relating to an incident; automatically assessing which obligations are triggered by (a) determining an incident severity level based on the inputs and the first rules, and (b) determining which obligations are triggered based on whether the incident severity level meets the respective threshold for each obligation; and outputting a display showing each triggered obligation and related information.

In some examples, a computer system may include: a memory; one or more processors; a set of instructions stored in the memory and configured to be executable by the one or more processors to: receive, via a user interface, values for each of a plurality of configurable settings, wherein the configurable settings include first rules relating inputs to severity levels and second rules relating one or more obligations to a respective threshold severity level; store the one or more configurable settings; receive as inputs, via a form displayed on the user interface, one or more field values relating to an incident; automatically assess which obligation(s) are triggered by (a) determining an incident severity level based on the inputs and the first rules, and (b) determining what obligations are triggered based on whether the incident severity level meets the respective threshold for each obligation; and output a display showing each triggered obligation and related information.

Systems of the present disclosure may include one or more of the following features:
Intelligent decision-support notification to reduce or eliminate subjectivity inherent in manual approaches to assessing an incident against a risk matrix.
Cross-functional communication to allow a cybersecurity group to collaborate across IT, privacy, compliance, and legal teams, e.g., to more swiftly begin documenting and assessing organizational response to a breach.
Proof of compliance (audit trail) to provide a transparent process to internal and external stakeholders, offering inherent traceability and defensibility.
Increased controls to simplify record-keeping and create streamlined, documentable processes.
Reduction or elimination of over- and under-reporting of incidents, potentially reducing fines imposed by regulatory bodies and impact on the organization's reputation.
Customizability to fit an organization's unique culture of compliance and risk via the ability to create rules based on a business case unique to the organization, and specific to each organization's definition of material harm.

Features, functions, and advantages may be achieved independently in various embodiments of the present disclosure, or may be combined in yet other embodiments, further details of which can be seen with reference to the following description and drawings.

### BRIEF DESCRIPTION OF THE DRAWINGS

FIG. 1 is a schematic diagram depicting an illustrative configurable compliance management system in accordance with aspects of the present disclosure.

FIG. 2 is a flow chart depicting steps of an illustrative method for managing compliance with obligations according to the present teachings.

### DETAILED DESCRIPTION

Various aspects and examples of a configurable compliance management system, as well as related methods, are described below and illustrated in the associated drawings. Unless otherwise specified, a configurable compliance management system in accordance with the present teachings, and/or its various components, may contain at least one of the structures, components, functionalities, and/or variations described, illustrated, and/or incorporated herein. Furthermore, unless specifically excluded, the process steps, structures, components, functionalities, and/or variations described, illustrated, and/or incorporated herein in connection with the present teachings may be included in other similar devices and methods, including being interchangeable between disclosed embodiments. The following description of various examples is merely illustrative in nature and is in no way intended to limit the disclosure, its application, or uses. Additionally, the advantages provided by the examples and embodiments described below are illustrative in nature and not all examples and embodiments provide the same advantages or the same degree of advantages.

### Definitions

The following definitions apply herein, unless otherwise indicated.

“Comprising,” “including,” and “having” (and conjugations thereof) are used interchangeably to mean including but not necessarily limited to, and are open-ended terms not intended to exclude additional, unrecited elements or method steps.

Terms such as “first”, “second”, and “third” are used to distinguish or identify various members of a group, or the like, and are not intended to show serial or numerical limitation.

“Processing logic” describes any suitable device(s) or hardware configured to process data by performing one or more logical and/or arithmetic operations (e.g., executing coded instructions). For example, processing logic may include one or more processors (e.g., central processing units (CPUs) and/or graphics processing units (GPUs)), microprocessors, clusters of processing cores, FPGAs (field-programmable gate arrays), artificial intelligence (AI) accelerators, digital signal processors (DSPs), and/or any other suitable combination of logic hardware.

“Providing,” in the context of a method, may include receiving, obtaining, purchasing, manufacturing, generating, processing, preprocessing, and/or the like, such that the object or material provided is in a state and configuration for other steps to be carried out.

In this disclosure, one or more publications, patents, and/or patent applications may be incorporated by reference. However, such material is only incorporated to the extent that no conflict exists between the incorporated material and the statements and drawings set forth herein. In the event of any such conflict, including any conflict in terminology, the present disclosure is controlling.

### Overview

Exemplary embodiments of the present disclosure solve the problems of how to consistently and defensibly apply an organization's own risk criteria to one or more incidents and how to deliver notification guidance based on the organization's unique notification obligations for any type of obligation, including any kind of regulatory or contractual obligations such as those set forth by, e.g., the SEC, EPA, EEOC, etc., an organization's internal departments, and/or its contracting partners.

Described herein is a system for codifying an organization's risk criteria, evaluating each unique incident against the risk criteria, and subsequently executing an automated workflow to identify regulatory and internal obligations. Also provided is an administrative interface to configure and encode the organization's unique risk criteria and notification obligations. A configurable and responsive interface (e.g., web form) captures incident details which feed into an assessment engine to evaluate incident severity and identify subsequent obligations.

A configurable risk assessment engine ingests input variables and applies each customer's unique definition of “materiality” through one or more rules based on external regulators and internal business rules. The output lays out obligations the company should execute to meet obligations from one or more obligation sources (e.g., jurisdictions).

A dynamic graphical user interface (“GUI”) allows a user to input unique organization risk definitions and impacts to support their decision making. The GUI outputs a summarized view of the assessment of all input incident information, providing the ability for the user to quickly understand the level of severity of an individual incident and take action accordingly.

In some examples, the configurable compliance management system includes receiving an obligation, the obligation defining a particular responsibility of the organization to an obligation source, associating the obligation with an obligation-triggering level of risk, and associating an action to take if the obligation is triggered. The system may receive from the user, e.g., via a compliance server in response to an incident involving the obligation, information corresponding to the incident, and automatically assess whether the obligation is triggered based on a comparison of the incident information to the compliance rule(s). The system outputs risk assessment and guidance information via the GUI to provide an impact summary indicating whether the rule was violated, one or more entities implicated or impacted in the incident, and one or more actions to take (e.g., a notification schedule). The system may also receive and store further information from the user regarding decisions made in each case, dates of compliance, etc.

Aspects of the configurable compliance management system may be embodied as a computer method, computer system, or computer program product. Accordingly, aspects of the system may take the form of an entirely hardware embodiment, an entirely software embodiment (including firmware, resident software, micro-code, and the like), or an embodiment combining software and hardware aspects, all of which may generally be referred to herein as a “circuit,” “module,” or “system.” Furthermore, aspects of the system may take the form of a computer program product embodied in a computer-readable medium (or media) having computer-readable program code/instructions embodied thereon.

Any combination of computer-readable media may be utilized. Computer-readable media can be a computer-readable signal medium and/or a computer-readable storage medium. A computer-readable storage medium may include an electronic, magnetic, optical, electromagnetic, infrared, and/or semiconductor system, apparatus, or device, or any suitable combination of these. More specific examples of a computer-readable storage medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, and/or any suitable combination of these and/or the like. In the context of this disclosure, a computer-readable storage medium may include any suitable non-transitory, tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, and/or any suitable combination thereof. A computer-readable signal medium may include any computer-readable medium that is not a computer-readable storage medium and that is capable of communicating, propagating, or transporting a program for use by or in connection with an instruction execution system, apparatus, or device.

Program code embodied on a computer-readable medium may be transmitted using any appropriate medium, including but not limited to wireless, wireline, optical fiber cable, RF, and/or the like, and/or any suitable combination of these.

Computer program code for carrying out operations for aspects of the system may be written in one or any combination of programming languages, including an object-oriented programming language (such as Java, C++), conventional procedural programming languages (such as C), and functional programming languages (such as Haskell). Back ends may be created using, e.g., NestJS, front ends using, e.g., Angular, and databases using Postgres and/or the like. Mobile apps may be developed using any suitable language, including those previously mentioned, as well as Objective-C, Swift, C#, HTML5, and the like. The program code may execute entirely on a user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), and/or the connection may be made to an external computer (for example, through the Internet using an Internet Service Provider).

Aspects of the system may be described below with reference to flowchart illustrations and/or block diagrams of methods, apparatuses, systems, and/or computer program products. Each block and/or combination of blocks in a flowchart and/or block diagram may be implemented by computer program instructions. The computer program instructions may be programmed into or otherwise provided to processing logic (e.g., a processor of a general purpose computer, special purpose computer, field programmable gate array (FPGA), or other programmable data processing apparatus) to produce a machine, such that the (e.g., machine-readable) instructions, which execute via the processing logic, create means for implementing the functions/acts specified in the flowchart and/or block diagram block(s).

Additionally or alternatively, these computer program instructions may be stored in a computer-readable medium that can direct processing logic and/or any other suitable device to function in a particular manner, such that the instructions stored in the computer-readable medium produce an article of manufacture including instructions which implement the function/act specified in the flowchart and/or block diagram block(s).

The computer program instructions can also be loaded onto processing logic and/or any other suitable device to cause a series of operational steps to be performed on the device to produce a computer-implemented process such that the executed instructions provide processes for implementing the functions/acts specified in the flowchart and/or block diagram block(s).

Any flowchart and/or block diagram in the drawings is intended to illustrate the architecture, functionality, and/or operation of possible implementations of systems, methods, and computer program products according to aspects of the system. In this regard, each block may represent a module, segment, or portion of code, which comprises one or more executable instructions for implementing the specified logical function(s). In some implementations, the functions noted in the block may occur out of the order noted in the drawings. For example, two blocks shown in succession may, in fact, be executed substantially concurrently, or the blocks may sometimes be executed in the reverse order, depending upon the functionality involved. Each block and/or combination of blocks may be implemented by special purpose hardware-based systems (or combinations of special purpose hardware and computer instructions) that perform the specified functions or acts.

### Examples, Components, and Alternatives

The following sections describe selected aspects of illustrative configurable compliance management systems, as well as related systems and/or methods. The examples in these sections are intended for illustration and should not be interpreted as limiting the scope of the present disclosure. Each section may include one or more distinct embodiments or examples, and/or contextual or related information, function, and/or structure.

### A. Illustrative Configurable System and Method

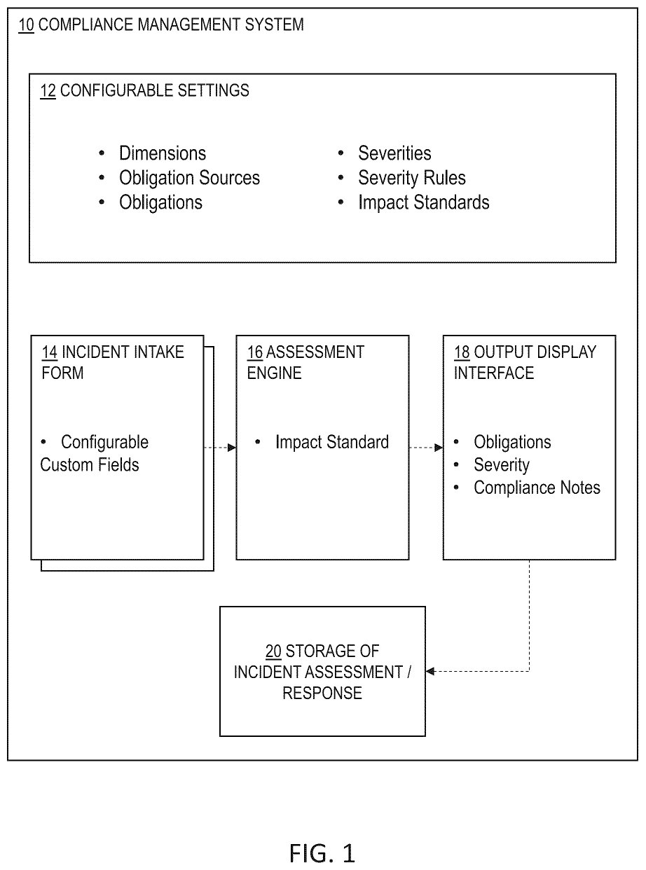

As shown in FIG. 1, this section describes an illustrative configurable compliance management system 10, which is an example of the systems described above.

FIG. 1 is a schematic block diagram depicting computer-implemented obligation compliance system 10. System 10 includes a set of configurable settings 12, which may include incident dimension definitions, obligation source information, obligations, severity levels, severity rules, impact standards, and/or the like. Each of these items may include one or more sets of rules, values, strings, and/or visual representations that are configurable by the user organization to create a customized compliance system. One or more appropriate user interfaces are provided for the user to edit each of the configurable settings.

An incident dimension may include a general topic, such as security, privacy, record management, compliance, fraud, safety, policy violation, etc. Each dimension defined by the user organization is given an associated assignee and status. Each dimension may have associated notes, attachments, and tasks, and at runtime the user interacts with the dimension via an incident intake form 14. These forms are configured to have custom fields defined by the user organization, such that completing the fields (e.g., by answering associated questions) provides adequate information to assess the incident's severity level and to properly document the situation.

An assessment engine 16 is executable on demand, automatically, or both, to consider the information provided via intake form 14 based on one or more impact standards configured by the user. The assessment engine outputs a result that indicates the severity level of the incident, as well as what obligations have been triggered by the incident's severity level.

The output of assessment engine 16 is displayed in a GUI or output display interface 18, listing the various obligations and compliance deadlines. In some examples, further guidance may be provided regarding each triggered obligation. In some examples, the severity level may be visually indicated by an icon, chart, color, virtual gauge, and/or the like.

Fields may be present on display interface 18, such that the user can enter notes and information regarding (a) the degree to which the organization's performance complies with each obligation, and/or (b) when the obligation was complied with. Information regarding the incident is stored in a memory 20 for archiving and auditing purposes, either automatically or on demand, to include the information gathered from incident intake form 14, the output of assessment engine 18, and/or the user's entered information from display interface 18.

Various aspects of system 10 will now be described further.

A compliance-enabled incident dimension (a dimension) may be defined by a dimension definition (see below). Each dimension may have an assignee and a status. Each dimension may further comprise associated notes, attachments, and/or tasks.

The dimension definitions include an incident intake form having custom field definitions, optionally including conditional field display logic, a default assignee, and other options. Each definition may be configured to include associated severity levels, severity rules, impact standards, obligation sources, and/or obligations.

An obligation source (e.g., a jurisdiction) may include any suitable legal or regulatory domain or entity (possibly internal) to which the organization may have obligations. Each obligation source is associated with an impact standard (see below), and may be configured to include a name and description. Multiple obligation sources can be associated with an impact standard; for example, if a company is subject to SEC jurisdiction, and the company's rules state notification obligations to multiple entities or people related to that jurisdiction. One or more obligations will be associated with each obligation source.

An obligation is a particular responsibility of the organization with respect to an obligation source and is associated to exactly one threshold severity level. If an incident's severity level is at or above (i.e., worse than) that level, then the obligation is triggered. Each obligation includes the relevant party (e.g., to be notified), a description of the obligation, the severity level at which obligation is triggered, and a timeline (length of time by which the obligation must be carried out). For example, an obligation may be “Report information X to obligation source Y within Z hours, using communication method W.”

A configurable severity level function (or rule) may include any suitable function configured by the user to receive one or more custom field values from the incident form and to output a severity level based on the values received. Each field of the incident intake form may be set up to include responses in the form of a checkbox, currency, date, dropdown menu, number, radio button, and/or a text field. Some fields may be informational, while others may be utilized by the severity level function(s). For example, an input affecting severity may be whether or not there is media attention, but there may also be an informational text field to list which reporter is involved. The user matches or creates Boolean logic rules to output a severity level, such as one selected from the following list: Low, Moderate, Notable, High, Critical.

An impact standard may include a set of one or more severity rules used to determine impact from a specific perspective. In some examples, the impact standard may be referred to as a risk severity matrix. The impact standard is processed by the system when a dimension is assessed, to report out the severity level of an incident. An impact standard may be associated with one or more obligation sources. The user organization may configure, in the context of a dimension definition, one or more impact standards by constructing sets of severity rules. For example, an administrator might configure one standard for ‘Risk of harm to the business’ and another for ‘Risk of harm to critical infrastructure’. In some examples, the user organization can select a custom field, an operator, and an operand to create a condition, and then (optionally) use AND/OR conjunctions and grouping to join multiple conditions together. Once joined, this set of conditions is associated with a severity level as an output, thereby creating a severity rule. The set of one or more of these severity rules will constitute the impact standard.

In some examples, a severity rule may list each relevant field, say whether it “is” or “contains” or “exceeds” (etc.), and list the value (answer) of concern. For example, “Potential for regulatory fines” “is” “more than $25K”. The organization can have lists of these field value thresholds, and then decide whether all must be met or only some of them in order to deem the incident to have a given severity. The impact standard comprises the set of all severity levels in a given context and their associated rules.

The output display may include an overall severity and the relevant obligation source, as well as the triggered obligations and related guidance. Fields may be provided for the user's decision and compliance date/time. Within the display, a user may view each obligation source and its obligations. An explanation may be required if the user's decision varies from the obligation and/or the guidance.

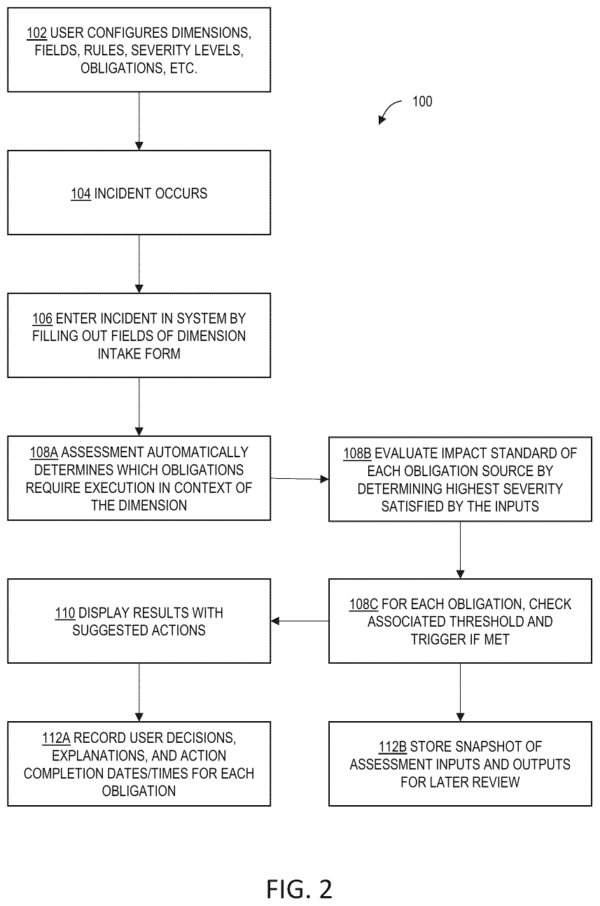

FIG. 2 is a flowchart illustrating steps performed in an illustrative method 100, and may not recite the complete process or all steps of the method. Although various steps of method 100 are described below and depicted in FIG. 2, the steps need not necessarily all be performed, and in some cases may be performed simultaneously or in a different order than the order shown.

Step 102 of method 100 includes configuring various configurable aspects of a configurable compliance management system.

Step 104 of method 100 includes recognizing that a potentially obligation-triggering event has occurred.

Step 106 of method 100 includes entering the incident into the system by filling out fields (e.g., answering questions) of an incident intake form.

Steps 108A-108C of method 100 include utilizing the system to assess the severity of the incident based on one or more answers from step 106 and a relevant impact standard.

Step 110 of method 100 includes displaying the results of the assessment, with associated actions.

Step 112A and 112B of method 100 include storing relevant information for documentation of the response, as well as for future retrieval and auditing purposes.

### B. Further Discussion

Generally speaking, the present technology may be directed to managing compliance with obligations. It will be understood that the term “obligations” may be understood to encompass a wide variety of regulatory and/or contractual reporting obligations according to the business lines and regulatory environments of the entrusted entity.

According to some examples, the present technology is directed to generating risk assessments (as defined by the user organization) for obligations (as defined by the user organization). These risk assessments provide specific information to the user organization regarding the severity of the obligations relative to a rule (as provided by the user organization). Additionally, the risk assessment may provide information regarding the data sensitivity for the obligations. That is, the risk assessment may determine if the type of data that was exposed is highly sensitive information, or otherwise “material” to the business operations, financial condition, or operational condition of the user organization. The relative sensitivity for different categories of data may be delineated in the selected rules and may require delineation in the context of each obligation.

The present technology determines the severity and/or data sensitivity for an obligation by collecting incident data directly from a user organization. This incident data may be compared against one or more selected rules as defined by the user organization to determine the severity and/or data sensitivity for the obligations. In some instances, the present technology may model the incident data to the one or more selected rules.

In some examples, the selected rules may comprise abstracted or mathematically expressed rules that have been generated from the text of the relevant obligation. Applying a selected rule to the incident data may yield values for the severity and/or the data sensitivity of the obligations.

In some examples, the risk assessment may provide indication to the user organization that an obligation has occurred. More specifically, if the severity of the obligations and/or the data sensitivity of the obligations when compared to the selected rules indicates that the incident data have violated at least one of the selected rules, the risk assessment may include an indication that an obligation has been created. An obligation may require the user organization to notify a regulator, internal department, and/or contracting partner.

In some examples, the risk assessment may include a risk level that is associated with a color. More specifically, a hue of the color is associated with the severity of the obligations as determined by the comparison or modeling of the incident data.

According to the present disclosure, the system may generate a notification schedule for a user organization along with mechanisms that aid the user organization in gathering pertinent information that is to be provided to the one or more regulatory agencies, internal departments, and/or contractual partners.

In some examples, the system may be implemented in a cloud-based computing environment, or as a web server that is particularly purposed to manage obligations. In general, a cloud-based computing environment is a resource that typically combines the computational power of a large grouping of processors and/or that combines the storage capacity of a large grouping of computer memories or storage devices. For example, systems that provide a cloud resource may be utilized exclusively by their owners; or such systems may be accessible to outside users who deploy applications within the computing infrastructure to obtain the benefit of large computational or storage resources.

The cloud may be formed, for example, by a network of web servers, with each web server (or at least a plurality thereof) providing processor and/or storage resources. These servers may manage workloads provided by multiple users (e.g., cloud resource customers or other users). Typically, each user places workload demands upon the cloud that vary in real-time, sometimes dramatically. The nature and extent of these variations typically depend on the type of business associated with the user.

In some examples, the system may include a distributed group of computing devices such as web servers that do not share computing resources or workload. Additionally, the system may include a single computing device, such as a web server, that has been provisioned with one or more programs that are utilized to manage obligations.

User organizations may access and interact with the system via the client device through a web-based interface. The network connection may include any one of a number of private and public communications mediums such as the Internet.

Configurable compliance management systems of the present disclosure may be generally described as mechanisms for managing obligations. The system may manage an obligation by collecting incident data for the obligations from the user organization and then modeling the incident data to selected rules provided by the user organization. The modeling of the incident data may be utilized to generate a risk assessment for the obligations. The risk assessment may be utilized by a user organization to determine how best to respond to the obligations. The system is provided with a risk assessment engine.

### C. Illustrative Combinations and Additional Examples

This section describes additional aspects and features of configurable compliance management systems, presented without limitation as a series of paragraphs, some or all of which may be alphanumerically designated for clarity and efficiency. Each of these paragraphs can be combined with one or more other paragraphs, and/or with disclosure from elsewhere in this application, including the materials incorporated by reference in the Cross-References, in any suitable manner. Some of the paragraphs below expressly refer to and further limit other paragraphs, providing without limitation examples of some of the suitable combinations.

A1. A computer-implemented method, comprising:
receiving, via a user interface, values for each of a plurality of configurable settings, wherein the configurable settings include first rules relating inputs to severity levels and second rules relating obligations to a respective threshold severity level;
storing the one or more configurable settings in a memory;
receiving as inputs, via a form displayed on the user interface, one or more field values relating to an incident;
automatically assessing which obligations are triggered by (a) determining an incident severity level based on the inputs and the first rules, and (b) determining which obligations are triggered based on whether the incident severity level meets the respective threshold for each obligation; and
outputting a display showing each triggered obligation and related information.

A2. The method of A1, wherein outputting the display further comprises providing one or more input fields configured to receive information regarding compliance with the triggered obligations.

A3. The method of A2, further comprising storing received information regarding compliance with the triggered obligations in the memory, associated with the incident.

A4. The method of any one of paragraphs A1 through A3, further comprising storing the field values in the memory, associated with the incident.

A5. The method of any one of paragraphs A1 through A4, further comprising storing the incident severity level and the triggered obligations in the memory, associated with the incident.

A6. The method of any one of paragraphs A1 through A5, wherein determining the incident severity level includes comparing each of the field values to the associated severity levels and outputting the most severe result obtained.

A7. The method of any one of paragraphs A1 through A6, wherein determining whether an obligation is triggered includes determining whether the incident severity level is at least as bad as the threshold severity for the respective obligation.

A8. The method of any one of paragraphs A1 through A7, wherein the one or more configurable settings include obligation sources associated with the obligations, wherein each obligation comprises a potential responsibility of the user to the obligation source.

B1. A computer system, comprising:
a memory;
one or more processors;
a set of instructions stored in the memory and configured to be executable by the one or more processors to:
   receive, via a user interface, values for each of a plurality of configurable settings, wherein the configurable settings include first rules relating inputs to severity levels and second rules relating one or more obligations to a respective threshold severity level;
   store the one or more configurable settings;
   receive as inputs, via a form displayed on the user interface, one or more field values relating to an incident;
   automatically assess which obligation(s) are triggered by (a) determining an incident severity level based on the inputs and the first rules, and (b) determining what obligations are triggered based on whether the incident severity level meets the respective threshold for each obligation; and
   output a display showing each triggered obligation and related information.

B2. The system of B1, wherein outputting the display further comprises providing one or more input fields configured to receive information regarding compliance with the triggered obligations.

B3. The system of B2, wherein the set of instructions are further configured to store received information regarding compliance with the triggered obligations, associated with the incident.

B4. The system of any one of paragraphs B1 through B3, wherein the set of instructions are further configured to store the field values, associated with the incident.

B5. The system of any one of paragraphs B1 through B4, wherein the set of instructions are further configured to store the incident severity level and the triggered obligations, associated with the incident.

B6. The system of any one of paragraphs B1 through B5, wherein determining the incident severity level includes comparing each of the field values to the associated severity levels and outputting the most severe result obtained.

B7. The system of any one of paragraphs B1 through B6, wherein determining whether an obligation is triggered includes determining whether the incident severity level is at least as bad as the threshold severity for the respective obligation.

B8. The system of any one of paragraphs B1 through B7, wherein the one or more configurable settings include obligation sources associated with the obligations, wherein each obligation comprises a potential responsibility of the user to the obligation source.

C1. A method for managing compliance with an obligation, the method comprising:
receiving an obligation, the obligation defining a rule requiring compliance;
associating a level of risk with non-compliance of the obligation;
associating an action with non-compliance of the obligation;
receiving, via a compliance server, in response to an incident involving the obligation, data that comprises information corresponding to the incident;
automatically generating, via the compliance server, a risk assessment and decision-support guidance whether the obligation is reportable from a comparison of the incident to the rule requiring compliance;
generating a risk assessment guidance interface to indicate whether the incident violates the rule requiring compliance;
wherein the risk assessment guidance interface comprises an impact summary indicating whether the rule was violated and one or more entities implicated or impacted in the incident; and wherein the receiving incident data further comprises: providing, in response to a determination of a violation of the rule, one or more questions to a display device that elicits information corresponding to the incident, the one or more questions tailored to specific criteria of the rule; and receiving responses to the one or more questions; and
generating a notification schedule when the comparison indicates that the incident violates and triggers a notification obligation according to the rule; and wherein the notification schedule comprises notification dates that are based upon the violated rule, along with notification requirements that describe information that is to be provided to a regulatory agency or to an affected company or individual whose personal data has been compromised, disclosed or released as a result of the incident.

### Conclusion

The disclosure set forth above may encompass multiple distinct examples with independent utility. Although each of these has been disclosed in its preferred form(s), the specific embodiments thereof as disclosed and illustrated herein are not to be considered in a limiting sense, because numerous variations are possible. To the extent that section headings are used within this disclosure, such headings are for organizational purposes only. The subject matter of the disclosure includes all novel and nonobvious combinations and subcombinations of the various elements, features, functions, and/or properties disclosed herein. The following claims particularly point out certain combinations and subcombinations regarded as novel and nonobvious. Other combinations and subcombinations of features, functions, elements, and/or properties may be claimed in applications claiming priority from this or a related application. Such claims, whether broader, narrower, equal, or different in scope to the original claims, also are regarded as included within the subject matter of the present disclosure.

1. A computer-implemented method, comprising:
receiving, via a user interface, values for each of a plurality of configurable settings, wherein the configurable settings include first rules relating inputs to severity levels and second rules relating obligations to a respective threshold severity level;
storing the one or more configurable settings in a memory;
receiving as inputs, via a form displayed on the user interface, one or more field values relating to an incident;
automatically assessing which obligations are triggered by (a) determining an incident severity level based on the inputs and the first rules, and (b) determining which obligations are triggered based on whether the incident severity level meets the respective threshold for each obligation; and
outputting a display showing each triggered obligation and related information.

2. The method of claim 1, wherein outputting the display further comprises providing one or more input fields configured to receive information regarding compliance with the triggered obligations.

3. The method of claim 2, further comprising storing received information regarding compliance with the triggered obligations in the memory, associated with the incident.

4. The method of claim 1, further comprising storing the field values in the memory, associated with the incident.

5. The method of claim 1, further comprising storing the incident severity level and the triggered obligations in the memory, associated with the incident.

6. The method of claim 1, wherein determining the incident severity level includes comparing each of the field values to the associated severity levels and outputting the most severe result obtained.

7. The method of claim 1, wherein determining whether an obligation is triggered includes determining whether the incident severity level is at least as bad as the threshold severity for the respective obligation.

8. The method of claim 1, wherein the one or more configurable settings include obligation sources associated with the obligations, wherein each obligation comprises a potential responsibility of the user to the obligation source.

9. A computer system, comprising:
a memory;
one or more processors;
a set of instructions stored in the memory and configured to be executable by the one or more processors to:
receive, via a user interface, values for each of a plurality of configurable settings, wherein the configurable settings include first rules relating inputs to severity levels and second rules relating one or more obligations to a respective threshold severity level;
store the one or more configurable settings;
receive as inputs, via a form displayed on the user interface, one or more field values relating to an incident;
automatically assess which obligation(s) are triggered by (a) determining an incident severity level based on the inputs and the first rules, and (b) determining what obligations are triggered based on whether the incident severity level meets the respective threshold for each obligation; and
output a display showing each triggered obligation and related information.

10. The system of claim 9, wherein outputting the display further comprises providing one or more input fields configured to receive information regarding compliance with the triggered obligations.

11. The system of claim 10, wherein the set of instructions are further configured to store received information regarding compliance with the triggered obligations, associated with the incident.

12. The system of claim 9, wherein the set of instructions are further configured to store the field values, associated with the incident.

13. The system of claim 9, wherein the set of instructions are further configured to store the incident severity level and the triggered obligations, associated with the incident.

14. The system of claim 9, wherein determining the incident severity level includes comparing each of the field values to the associated severity levels and outputting the most severe result obtained.

15. The system of claim 9, wherein determining whether an obligation is triggered includes determining whether the incident severity level is at least as bad as the threshold severity for the respective obligation.

16. The system of claim 9, wherein the one or more configurable settings include obligation sources associated with the obligations, wherein each obligation comprises a potential responsibility of the user to the obligation source.
